(19) United States
(12) Patent Application Publication
(10) Pub. No.: US 2009/0083479 A1
(43) Pub. Date: Mar. 26, 2009

(54) MULTIPORT SEMICONDUCTOR MEMORY DEVICE AND ASSOCIATED REFRESH METHOD

(75) Inventors: Jae-Wook LEE, Yongin-si (KR); Youn-Cheul KIM, Seoul (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/183,545

(22) Filed: Jul. 31, 2008

(30) Foreign Application Priority Data
Aug. 1, 2007 (KR) 10-2007-0077384

(51) Int. Cl. G06F 12/00

(52) U.S. Cl. 711/106; 711/E12.001

(57) ABSTRACT

A semiconductor memory device used in a multiprocessor system is configured to perform a partial refresh operation based on the state of an access port instead of performing a refresh operation per memory bank via a bank address. The multiprocessor system includes a plurality of processors and the memory device includes a memory cell array and a plurality of ports correspondingly connected to the plurality of processors. The memory cell array includes a plurality of memory areas having predetermined memory capacity. Each of the plurality of memory areas is assigned to at least one of the plurality of ports. Each of the plurality of memory areas is accessed by any one of at least one corresponding processors through a corresponding port. A refresh controller is disposed between the plurality of ports and the plurality of memory areas and is configured to refresh at least one memory area assigned to a port connected to a processor which is in a predetermined operating mode.

### CROSS REFERENCE TO RELATED APPLICATIONS

This application claims the benefit of Korean Patent Application 10-2007-0077384 filed on Aug. 1, 2007, the disclosure of which is incorporated herein by reference.

### BACKGROUND OF THE INVENTION

1. Field of the Invention

Embodiments of the invention relate to semiconductor memory devices. More particularly, embodiments of the invention relate to a semiconductor memory device in which a plurality of ports is connected to a corresponding plurality of processors providing access to particular memory areas.

2. Discussion of Related Art

A semiconductor memory device having two access ports is referred to as a dual-port memory and a semiconductor memory having a plurality of access ports is called a multiport memory device. A typical dual-port memory is well known in the field and may be utilized as an image processing video memory having a RAM port accessible in a random sequence and a SAM port accessible only in a serial sequence. Alternatively, a dynamic random access memory which does not have an SAM port and for which a memory cell array constructed of DRAM cells is divided by a predetermined memory capacity unit, respective processors can perform an access operation through a plurality of access ports. A multiport memory described herein is distinguished from the dual port memory as described below.

In mobile communication systems, multiprocessor systems are employed to provide high speed and smooth operation. A nonvolatile memory stores boot codes associated with each processor and a volatile memory (e.g. DRAM) is also connected to each corresponding processor. In this manner, the DRAM and flash memory are each adapted for a processor which increases system complexity and costs.

Multiport semiconductor memory devices have been employed to provide relatively more compact size, lower cost and high functionality in multiprocessor systems. In these multiport semiconductor memory devices, ports are arranged corresponding to the number of processors and a memory cell array is divided into a plurality of memory areas having independent access paths. For example, when the plurality of processors are employed as hosts to a portable multimedia device, a first host may provide a baseband processor function to perform a predetermined task (e.g., modulation and demodulation of a communication signal). A second host may function as an application processor for performing a user convenience function to deal with communication data or media applications. In multiprocessor systems employing one DRAM having a shared memory area accessed by multiple processors, DRAM and flash memory are commonly used without being assigned to every processor. This avoids the complication associated with system size by decreasing the number of memory devices.

A partial function of the multiport semiconductor memory is substantially similar to the function of a DRAM type memory manufactured by Samsung Electronics Co. Ltd as “oneDRAM.” This oneDRAM is a fusion memory chip that greatly increases data processing speeds between a communication processor and a media processor in a mobile device. Generally, two processors require two memory buffers. However, a oneDRAM solution can route data between processors through a single chip, thereby avoiding the need for two memory buffers. This oneDRAM configuration substantially reduces the time required for data transmission between processors by employing a dual-port approach. A single oneDRAM module can replace at least two mobile memory chips within a high-performance smart-phone or other multimedia-rich handset device. As data processing speeds between processors increase, oneDRAM type devices can reduce power consumption by about 30% as compared with power consumption for existing devices. This may also reduce the number of chips required for such a device which consequently reduces the total die area coverage by about 50%. Accordingly the operating speeds of these devices can increase by about five times, battery life may be prolonged and handset design may be slimmer.

In a multiport semiconductor memory device which employs a portion of the oneDRAM function, a memory area or memory areas are assigned to each port connected to each processor. For example, when a first host is coupled to a first port, first/second memory bank of memory banks is operationally connected to the first port. When a second host is connected to a second port, the second port is operationally connected to a third memory bank. As a result, the first host can access the first/second memory bank via the first port and the second host can access the third memory bank via the second port. The memory cell array in this type of device may be comprised of general DRAM memory cells which require a refresh operation. That is, a DRAM memory cell is generally constructed of one access transistor and a storage capacitor. However, charge stored in the storage capacitor is influenced by leakage current over time which eventually results in data loss. To prevent this data loss, a DRAM refresh operation is needed to repeatedly read and write data stored in the storage capacitor.

This DRAM refresh operation is largely classified as an auto-refresh and a self-refresh. In the auto-refresh operation, an auto-refresh command is applied for a given time interval from an external source to refresh the DRAM cells. In the self-refresh operation, a specific refresh command is not applied from an external source and only a self-refresh start signal is given. The memory cell refresh is performed by using an internal timer through the semiconductor memory device itself until a self-refresh exit signal is applied. This self-refresh mode reduces power consumption. Thus, a circuit block having, for example, an input buffer or a synchronous circuit, which is not related to the self-refresh operation, is turned off to substantially reduce power consumption when performing this self-refresh operation.

In performing the refresh operation in the multiport semiconductor memory device, the refresh operation must be performed for all memory banks where a read or write operation is applied to all ports as a data access operation is intercepted. Thus, it is difficult to safely ensure data access for other memory areas independently of a memory area undergoing the refresh operation. In addition, when a processor connected to an optional port does not perform a data access operation for a corresponding memory bank and the memory bank is provided as a power-down mode, a bank address is generally applied to perform the self-refresh operation control for a corresponding bank. This causes complications in the refresh control operation.

### SUMMARY OF THE INVENTION

Exemplary embodiments of the present invention are directed to a semiconductor memory device for use in a multiprocessor system capable of performing a refresh operation according to the state of a processor access port. In an exemplary embodiment, the multiprocessor system includes a plurality of processors and the semiconductor memory device includes a memory cell array and a plurality of ports correspondingly connected to the plurality of processors. The memory cell array includes a plurality of memory areas having predetermined memory capacity. Each of the plurality of memory areas is assigned to at least one of the plurality of ports. Each of the plurality of memory areas is accessed by any one of at least one corresponding processors through a corresponding port. A refresh controller is disposed between the plurality of ports and the plurality of memory areas. The refresh controller is configured to refresh at least one memory area assigned to a port connected to a processor which is in a predetermined operating mode. In the semiconductor memory device, a refresh operation per port can be performed according to an operating mode per port. A partial refresh may be performed according to a state of a port instead of performing a refresh operation on a per memory bank basis through the use of a bank address. This limits device control complications and reduces power consumption.

### BRIEF DESCRIPTION OF THE DRAWINGS

FIG. 1 is a block diagram illustrating a function of known main components of dynamic random access memory device;

FIG. 2 illustrates timings for operation of signals related to an auto-refresh operation of the known device shown in FIG. 1;

FIG. 3 illustrates timings for signals related to a self-refresh operation in the device of FIG. 1;

FIG. 4 is a block diagram schematically illustrating a multiprocessor system according to an embodiment of the invention;

FIG. 5 is a block diagram schematically illustrating a self-refresh performed through some ports of FIG. 4 according to an embodiment of the invention;

FIG. 6 is a block diagram schematically illustrating a multiprocessor system according to an embodiment of the invention;

FIGS. 7 and 8 are block diagrams schematically illustrating a self-refresh performed through some ports of FIG. 6 according to another embodiment of the invention;

FIG. 9 is a block diagram of general DRAM provided to describe a refresh controller adapted according to an embodiment of the invention;

FIG. 10 is a circuit diagram illustrating a portion of refresh control circuit referred to in FIG. 9;

FIG. 11 is a circuit diagram of refresh timer shown in FIG. 9;

FIG. 12 illustrates timings for operation in a self-refresh operation period;

FIG. 13 is a circuit and block diagram illustrating in detail a semiconductor memory device according to an embodiment of the invention;

FIG. 14A is a circuit diagram illustrating in detail a control unit of FIG. 13;

FIG. 14B is a timing diagram for gating signals PA and PB; and

FIG. 15 illustrates in detail a row or column address multiplexer referred to in FIG. 13.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

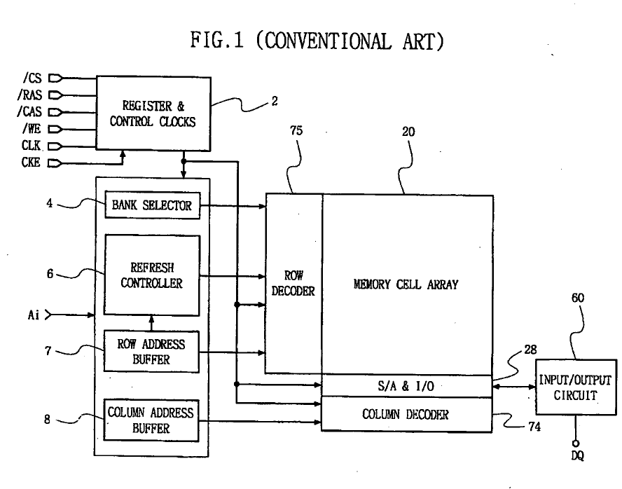

FIG. 1 is a block diagram illustrating main components of a general dynamic random access memory (DRAM) device with a refresh control path. The random access memory device includes memory cell array 20, row decoder 75, S/A & I/O 28, column decoder 74, input/output circuit 60, register & control clocks 2, bank selector 4, refresh controller 6, row address buffer 7 and column address buffer 8. Refresh controller 6 receives refresh-related signals from register & control clocks 2 to perform a refresh of the memory cell adapted within memory cell array 20. An external row address signal outputted from row address buffer 7 and an internal row address signal as a refresh address signal outputted from refresh controller 6 are applied to row decoder 75. Row decoder 75 selects a row (word line) of the memory cell array according to the internal row address signal in the refresh operating mode. When a row active operation is selected for a refresh operation, a level of potential stored in the memory cell is amplified through sense amplifier S/A and the data read in the sense amplifier is again stored in a corresponding memory cell without an external output. When the device is in a data read operating mode, column decoder 74 selects a column of the memory cell array according to an external column address signal after the row active operation and data is read through input/output circuit 60. This internal row address signal is generated by a refresh address counter.

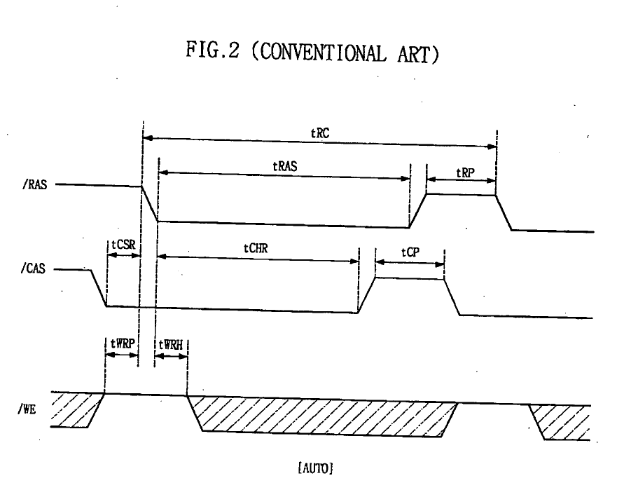

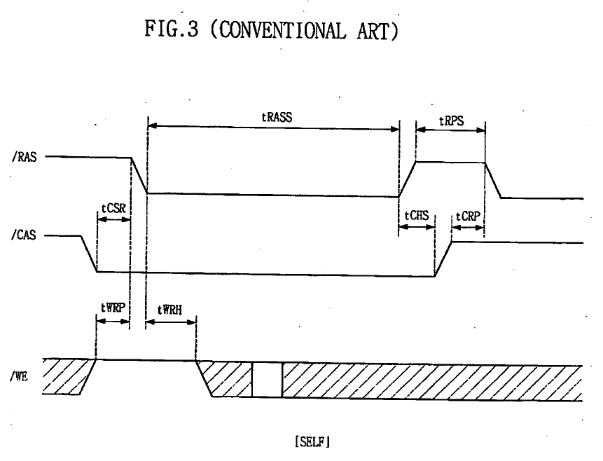

FIG. 2 illustrates signal timing for an auto-refresh operation and FIG. 3 illustrates timings for a self-refresh operation. External signals /CS, /RAS, /CAS, /WE, CLK and CKE are applied to register & control clocks 2 from a memory controller or microprocessor. External control signal /CS indicates a chip selection signal. External control signal /RAS indicates a row address strobe signal. External control signal /CAS indicates a column address strobe signal. External control signal /WE indicates a write enable signal. External control signal CLK indicates a clock signal and signal CKE indicates a clock enable signal. Signal /CAS first maintains a low level before signals /RAS and /WE definitely maintains a high level before the start of an operating mode. Reference characters tCSR, tCHR, tWRP and tWRH indicate /CAS setup time, /CAS hold time, /WE to /RAS precharge time and /WE to /RAS hold time respectively.

FIG. 3 illustrates timing associated with a self-refresh operation. When the start state continues for a predetermined time, a refresh request signal is automatically generated by a refresh timer even without the existence of an external control signal. Control signals from the RAS group are automatically generated within the memory device, and the self-refresh operation is performed by a generated row address signal. Consequently, when the /CAS signal transitions to a low level, the /RAS signal is maintained at a low level for interval tRASS which may be, for example, 100 microseconds. The refresh cycle continues for a given period corresponding to the internal timer operation. The self-refresh operation continues until the /RAS signal transitions to a high level. Reference characters tRPS, tRASS and tCHS each indicate a self-refresh /RAS precharge time, self-refresh /RAS pulse width and self-refresh /CAS hold time, respectively.

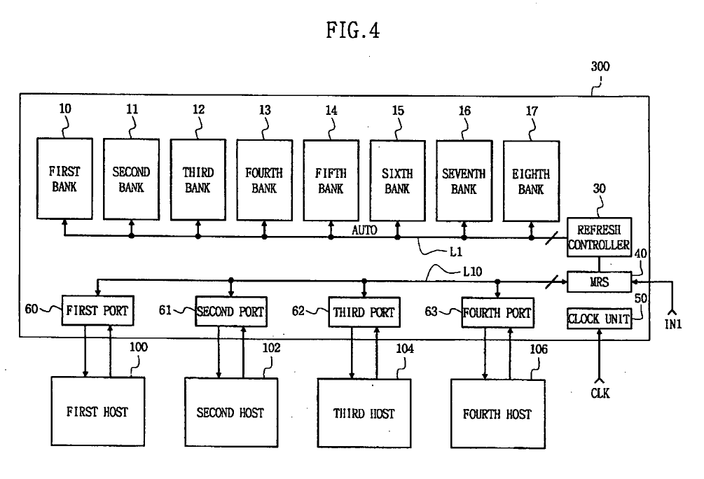

FIG. 4 is a block diagram illustrating a multiprocessor system including a multiport semiconductor memory device 300. A memory cell array is divided into eight memory banks 10-17 and the memory device has four ports 60-63. First port 60 is connected to first host 100, second port 61 is connected to second host 102, and third port 62 is connected to third host 104. A fourth port 63 is connected to fourth host 106. Each of the eight memory areas 10-17 is assigned to at least one of the ports 60-63 to allow any one of at least one corresponding host of hosts 100, 102, 104 and 106 to access thereto through a corresponding port. The division of memory areas 10-17 is predetermined based on a memory capacity unit within the memory cell array. For example, the first to third banks 10-12 may be accessed by the first host 100 through first port 60, and the fourth bank 13 may be accessed by second host 102 through second port 61. The fifth bank 14 may be accessed by third host 104 through third port 62, and sixth to eighth banks 15-17 may be accessed by fourth host 106 through fourth port 63. One bank or block may have memory storage of, for example, 64 Mb, 128 Mb, 256 Mb, 512 Mb or 1024 Mb. Refresh controller 30 is coupled to mode register set circuit 40 which is coupled to memory banks 10-17 through line L1 to get a refresh control. Clock unit 50 receives an external clock signal CLK and generates an internal clock. Mode register set circuit 40 is coupled bilaterally with ports 60-63 through line L10. Mode register set circuit 40 stores memory bank assignment information per port which may be changed by differentiating mode register set signals. Consequently, bank matching per port is flexible by changing an external control signal.

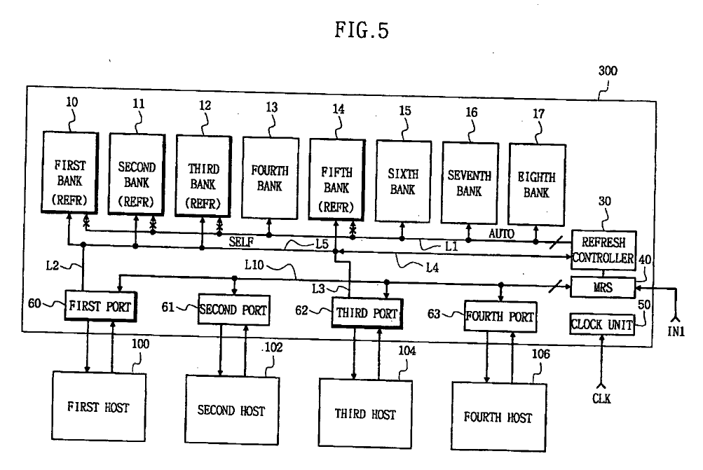

When access to all the memory banks 10-17 is performed in a multiprocessor system, an auto-refresh operation is performed through refresh controller 30. Alternatively, when first and second hosts 100 and 104 do not access memory banks through corresponding ports 60 and 62 of multiport semiconductor memory device 300, a power-down mode or sleep mode starts and a self-refresh operation for each port is performed as shown in FIG. 5. FIG. 5 is a block diagram schematically illustrating a self-refresh operation. When at least one of the ports 60-63 has a specific operating mode (for example, a power-down mode) according to a memory control state of the hosts 100, 102, 104 and 106, refresh controller 30 refreshes the memory areas (e.g. first, second, third and fifth banks), corresponding to a port having a self-refresh operating mode.

Hosts 100 and 104 are connected to the first and third ports corresponding to the memory areas assigned to particular ports. For example, first to third banks 10-12 are assigned to first port 60 and fifth bank 14 is assigned to third port 62. When the hosts 100 and 104 do not access to first to third banks 10, 11 and 12 and fifth bank 14, these banks become the target of the self-refresh operation through control lines L4 and L5 of refresh controller 30. In this manner, the self-refresh bank selection is not obtained by a bank selection address applied externally, but is obtained by reading bank assignment information associated with a port stored in mode register set circuit 40. This bank selection method simplifies the control of the self-refresh operation.

The self-refreshed memory banks have a reference character “REFR”. The host determines whether or not to perform a memory access operation and reads the memory assignment information per port through a corresponding port in the power-down mode. The first and third host 100 and 104 apply information associated with the memory banks to be self-refreshed to refresh controller 30 through lines L2, L3. The self-refresh operation is then performed for the first to third banks 10, 11 and 12 and fifth bank 14. Meanwhile, read/write or the auto-refresh operation is performed for fourth bank 13 and sixth to eighth banks 15-17. As a result, data access is valid independently of the self-refresh operation through the assigned memory banks corresponding to second port 61 and fourth port 63.

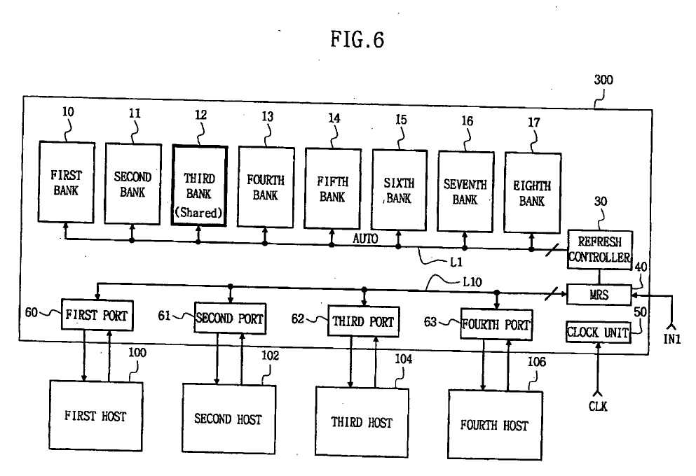

FIG. 6 is a block diagram illustrating a multiprocessor system based on the characteristic that third bank 12 is a shared memory area. Third bank 12 is accessed in common by first host 100 and second host 102 through first port 60 and second port 61. First bank 10 and second bank 11 may be dedicatedly accessed by first host 100 via first port 60. Third bank 12 may be commonly accessed by first host 100 and second host 102 through first and second ports 60 and 61. Fourth bank 13 may be dedicatedly accessed by second host 102 via second port 61. Fifth bank 14 and sixth bank 15 may be dedicatedly accessed by third host 104 via third port 62. Sixth to eighth banks 15-17 may be dedicatedly accessed by fourth host 106 via fourth port 63. First to fourth hosts 100, 102, 104 and 106 perform memory access without starting a power-down mode. An auto-refresh operation is also performed.

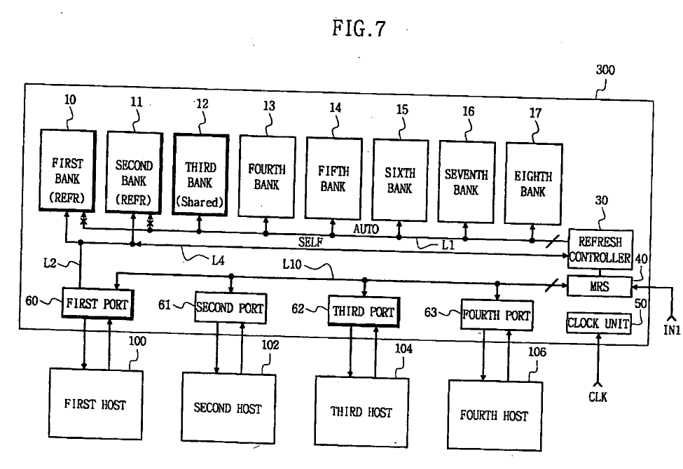

FIG. 7 is a block diagram illustrating a self refresh operation via some of the ports illustrated in FIG. 6. When memory access is not performed via first port 60, first bank 10 and second bank 11 become the target to be self-refreshed through control line L4 of refresh controller 30. Similarly, the bank selection of the self-refresh operation is not obtained by a bank selection address applied externally. Rather, the bank selection is obtained by reading bank assignment information per port stored in mode register set circuit 40. Meanwhile, since third bank 12 is commonly assigned to first port 60 and second port 61, even though the first host 100 does not perform an access operation, the third bank 12 does not become a self-refresh target to allow the second host 102 to access to the third bank 12 via second port 61. The self-refreshed memory banks have a reference character “REFR”. In this manner, first host 100 reads memory assignment information per port via first port 60 in the power-down mode and applies information of the memory banks to be self-refreshed to refresh controller 30 via lines L2 and L4. Then the self-refresh operation is performed for first bank 10 and second bank 11. Meanwhile, a read/write or auto-refresh operation is performed for third to eighth banks 12-17. As a result, the data access is valid independently of the self-refresh operation through the memory banks assigned to the second to fourth ports 61-63.

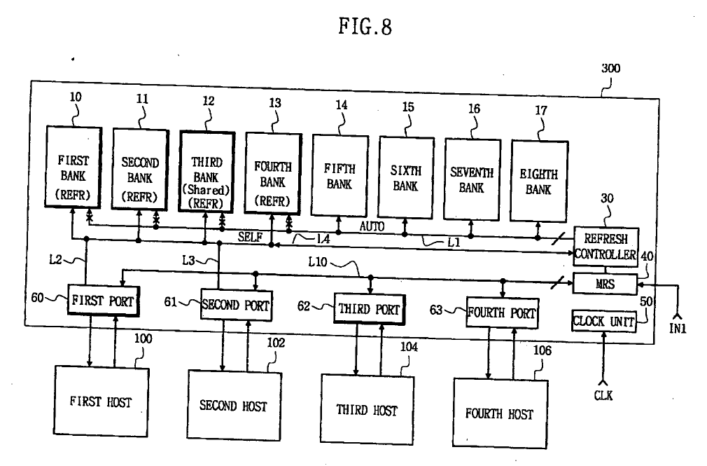

FIG. 8 is a block diagram illustrating a self refresh operation via some of the ports illustrated in FIG. 6. A self-refresh operation is performed through second port 61 in addition to the self-refresh operation performed through first port 60 of FIG. 7. In FIG. 8, when memory access is not performed through first port 60 and second port 61, first to fourth banks 10-13 become a self-refresh target through control line L4 of refresh controller 30. Similarly, the bank selection for the self-refresh operation is not obtained by a bank selection address applied externally. Rather, the bank selection is obtained by reading bank assignment information per port stored in mode register set circuit 40. In this manner, third bank 12 is a shared bank, but the first and second ports 60 and 61 are allocated for a power-down mode start. Thus, third bank 12 becomes the target memory bank to be self-refreshed.

As shown in FIG. 8, four self-refreshed memory banks have a reference character “REFR”. That is, the first and second hosts 100 and 102 read memory assignment information per port through first and second ports 60 and 61 in the power-down mode and apply information of the banks to be self-refreshed to refresh controller 30 via lines L2 and L3. The self-refresh operation is performed for first to fourth banks 10-13. Meanwhile, a read/write or auto-refresh operation is performed for fifth to eighth banks 14-17. As a result, data access is valid independently of the self-refresh operation through the assigned memory banks corresponding to third port 62 and fourth port 63. An input signal IN1 specifically applied to mode register set circuit 40 changes the memory bank assignment information per port through another path even without a change of the mode register set signal through the hosts.

In this manner, each port-based refresh operation for memory areas associated with the memory cell array is performed based on each port-based operating mode in a multiport semiconductor memory device. A partial refresh is performed according to a state of one of the plurality of ports instead of performing a bank-based refresh according to a memory bank address. This avoids control complications while reducing power consumption. In addition, the data access to other memory areas can be guaranteed independently of the memory area performing a refresh. This type of multiport semiconductor memory device can be applied to a system with only one memory, thereby reducing chip size and simplifying circuit design.

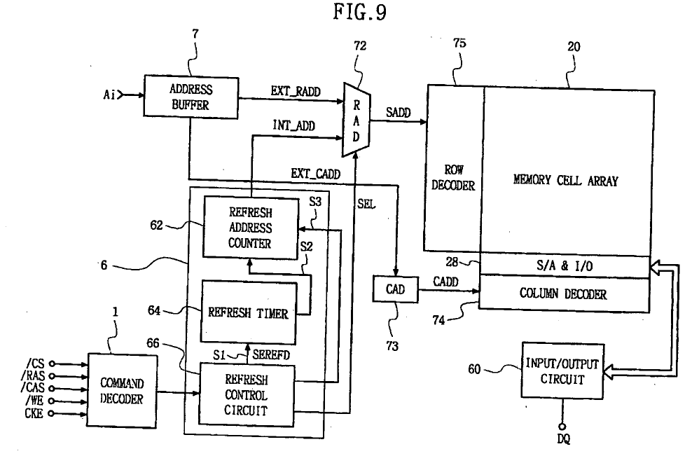

FIG. 9 is a block diagram of a general DRAM provided to describe in detail refresh controller 6 which comprises refresh address counter 62, refresh timer 64 and refresh control circuit 66. Refresh address counter 62 generates refresh internal address INT_ADD. Refresh timer 64 generates a refresh period signal. Refresh control circuit 66 applies self-refresh start signal SEREFD to refresh timer 64 and applies a counting enable signal to refresh address counter 62, and refresh address counter 62 applies the refresh internal address to row decoder 75. Refresh controller 6 may be used as refresh controller 30 referred to in the drawings according to embodiments of the invention without a change of function. Row address driver 72 applies refresh internal row address INT_ADD to row decoder 75 in response to selection signal SEL applied from refresh control circuit 66 in a refresh operation. Alternatively, reference character 73 indicates a column address driver for driving a column address and applying it to column decoder 74. Refresh control circuit 66 controls the auto-refresh operation or self-refresh operation depending upon the decoding signal of command decoder 1.

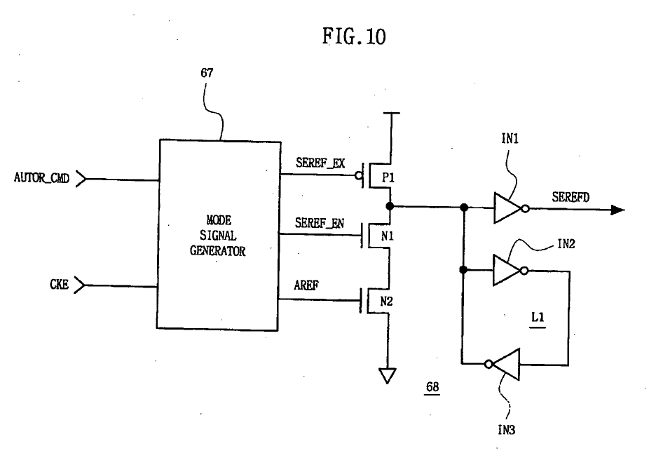

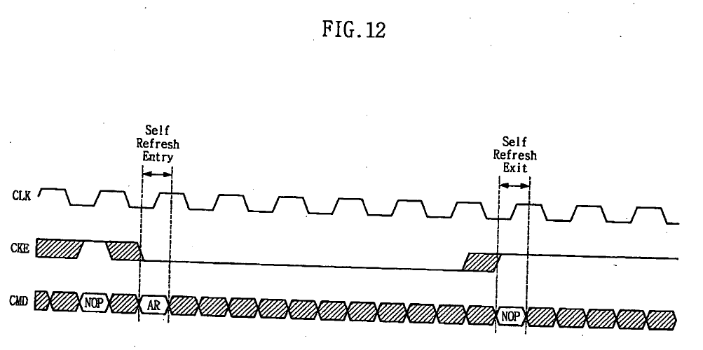

FIG. 10 is a circuit diagram illustrating in detail a portion of the refresh control circuit 66 referred to in FIG. 9. A wiring structure includes mode signal generator 67 and driving and latch circuit 68. Driving and latch circuit 68 comprises PMOS transistor P1, NMOS transistors N1 and N2, inverter IN1 and latch L1. Mode signal generator 67 receives auto-refresh command AUTOR_CMD and a clock enable signal CKE, and outputs logic signals that indicate a self-refresh exit signal SEREF-EX, a self-refresh start signal SEREF-EN and an auto-refresh control signal AREF according to the logic of the generated signal. For example, when the self-refresh start signal SEREF-EN and auto-refresh control signal AREF are at a logic high, an input terminal of inverter IN1 becomes a logic low and its output terminal becomes a logic high. Alternatively, if self-refresh exit signal SEREF-EX is at a high level, the output terminal of inverter IN1 becomes a logic low and the self-refresh operation is stopped. FIG. 12 illustrates timings for operation of signals related to the self-refresh start and exit for reference.

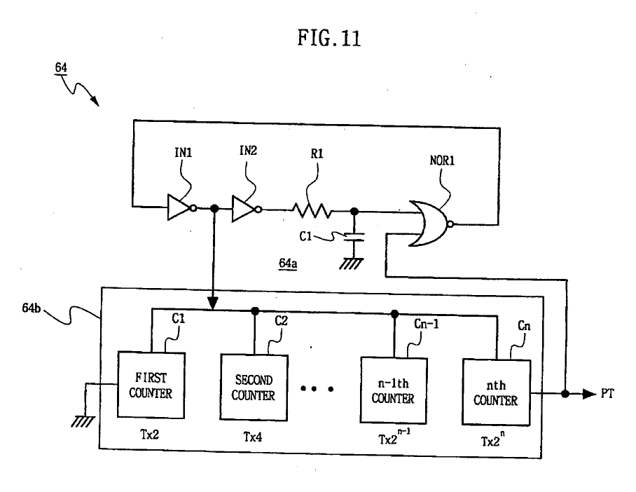

FIG. 11 is a circuit diagram illustrating in detail a refresh timer shown in FIG. 9. Basic-period circuit 64a and counter circuit unit 64b constitute the refresh timer, and basic-period circuit 64a comprises inverters 1N1 and IN2, resistor R1, capacitor C1, and NOR gate NOR1. Counter circuit unit 64b is comprised of a plurality of counters C1-Cn. The operation of the refresh timer is well known to those skilled in the art and a detailed description thereof is omitted herein.

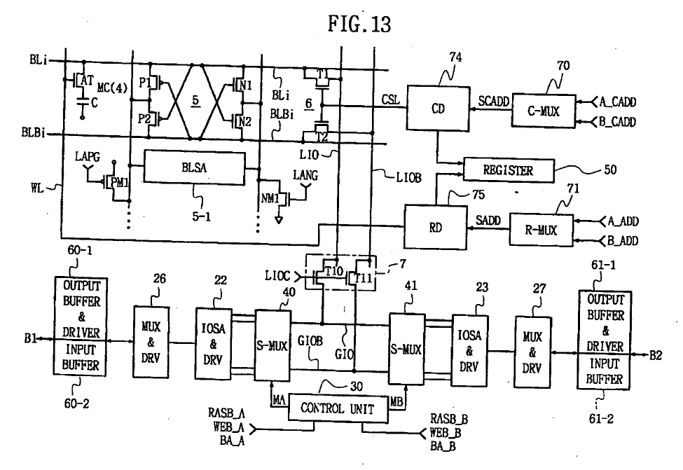

In the following description, the third bank 12 referred to in FIGS. 6 to 8 is accessed in common through mutually different ports. FIG. 13 is a circuit and block diagram of semiconductor memory device illustrating a multipath access to a shared memory area. First, an optional memory cell 4 of third bank 12 shown in FIG. 6 can be accessed by first host 100 and second host 102 through first and second ports 60 and 61 provided as mutually different ports. That is, third bank 12 is assigned as a shared memory area within the memory cell array. Second multiplexer 40 for a first port and a second multiplexer 41 for a second port are disposed symmetrically on the shared memory bank 12. Input/output sense amplifier and driver 22 for the first port and input/output sense amplifier and driver 23 for the second port are disposed symmetrically. Within the shared memory bank 12, DRAM cell 4 is constructed of one access transistor AT and storage capacitor C forms a unit memory device. DRAM cell 4 is connected with intersections of a plurality of word lines and bit lines forming a matrix type bank array. Word line WL shown in FIG. 13 is disposed between a gate of access transistor AT of DRAM cell 4 and row decoder 75. Row decoder 75 generates a row decoded signal in response to an output row address of row address multiplexer 71 and applies this signal to word line WL or register 50 for use of an interface. Bit line BLi constituting a bit line pair is coupled to a drain of access transistor AT and column selection transistor T1. A complementary bit line BLBi is coupled to column selection transistor T2. PMOS transistors P1 and P2 and NMOS transistors N1 and N2 are coupled to the bit line pair BLi, BLBi to constitute a bit line sense amplifier. Sense amplifier driving transistors PM1 and NM1 each receive drive signal LAPG, LANG, and drive bit line sense amplifier 5. Column selection gate 6 is constructed of column selection transistors T1 and T2 coupled to column selection line CSL transferring a column decoded signal of column decoder 74. Column decoder 74 applies a column decoded signal to column selection line and register 50 in response to a selection column address SCADD of column address multiplexer 70.

A local input/output line pair LIO, LIOB is coupled to first multiplexer 7. When transistors T10 and T11 constituting first multiplexer 7:F-MUX are turned on in response to a local input/output line control signal LIOC applied to the gates of transistors T10 and T11, local input/output line pair LIO, LIOB are coupled to global input/output line pair GIO, GIOB. The data associated with local input/output line pair LIO, LIOB is transferred to global input/output line pair GIO, GIOB during the data read operating mode. On the other hand, the write data applied to global input/output line pair GIO, GIOB is transferred to local input/output line pair LIO, LIOB in a data write operating mode. Local input/output line control signal LIOC may be a signal generated in response to a decoded output signal from row decoder 75. When a path decision signal MA outputted from control unit 30 has an active state, read data transferred to global input/output line pair GIO, GIOB is transferred to input/output sense amplifier and driver 22 via second multiplexer S-MUX 40. Input/output sense amplifier 22 amplifies the data whose signal level has weakened as a result of the transfer procedure through several data paths. Read data outputted from input/output sense amplifier 22 is transferred to first port 60-1 via multiplexer and driver 26. Meanwhile, path decision signal MB is in an inactive state and second multiplexer 41 is disabled. An access operation of second host 102 to shared memory bank 12 is intercepted. However, second host 102 can access the memory banks, except shared memory bank 12, through second port 61-1.

When path decision signal MA outputted from control unit 30 is in an active state, write data applied through first port 60-2 is transferred sequentially through multiplexer and driver 26, input/output sense amplifier and driver 22 and second multiplexer 40 to global input/output line pair GIO, GIOB. When first multiplexer 7:F-MUX is activated, the write data is transferred to local input/output line pair LIO, LIOB and then stored in selected memory cell 4. An output buffer and driver 60-1 and input buffer 60-2 shown in FIG. 13 may correspond to or be included in first port 60 of FIG. 6. Second multiplexers 40 and 41 have a mutually complementary operation to prevent two hosts from simultaneously accessing data of shared memory bank 12. First and second hosts 100 and 102 commonly use circuit devices and lines that are disposed between global input/output line pair GIO, GIOB and memory cell 4 in an access operation, and independently use input/output related circuit devices and lines between respective ports and second multiplexers 40 and 41. In particular, global input/output line pair GIO, GIOB (of shared memory bank 12), local input/output line pair LIO, LIOB (operationally connected to the global input/output line pair), bit line pair BL, BLB (operationally connected to the local input/output line pair through column selection signal CSL), bit line sense amplifier 5 adapted on the bit line pair BL, BLB (which senses and amplifies data of the bit line), and memory cell 4 (whose access transistor AT is connected to bit line BL) are shared by first and second hosts 100 and 102 through first and second ports 60 and 61.

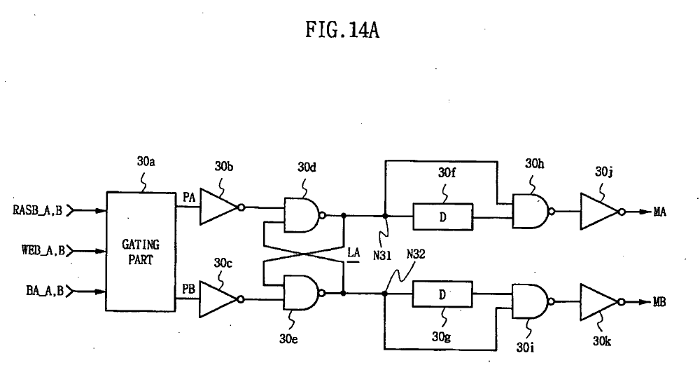

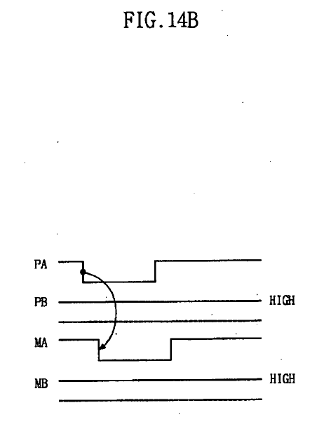

Register 50 functions as an interface unit to provide an interface between hosts. Register 50 is accessed by first and second hosts 100 and 102 and is constructed of a flip-flop, data latch or SRAM cell. Internal register 50 may be classified as a semaphore area, first mailbox area (mail box A to B), second mailbox area (mail box B to A), check bit area, and reserve area. Areas 51-55 may be commonly enabled by the specific row address and are individually accessed by an applied column address. For example, when row address 1FFF800h˜1FFFFFFh indicating a specific row area of shared memory bank 12 is applied, a portion of the row area of shared memory bank 12 is disabled and internal register 50 is enabled. In the semaphore area (which is a term familiar to processing system developers), a control authority for shared memory bank 12 is written. In the first and second mailbox areas, a message (e.g. authority request, transmission data such as a logical/physical address of flash memory or data size or address of shared memory to store data, or commands such as precharge, etc.) provided to a counterpart processor may be written according to a predetermined transmission direction. Control unit 30 controls a path that operationally connects shared memory bank 12 to one of the first and second hosts 100 and 102. Control unit 30 is configured similar to that shown in FIG. 14 to apply a path decision signal MA, MB to multiplexers 40 and 41. Path decision signal MA, MB operationally connects shared memory bank 12 to first port 60 or second port 61.

FIG. 14A is a circuit diagram illustrating in detail control unit 30 of FIG. 13 including a gating part 30a comprised of a plurality of logic gates. Gating part 30a receives bank selection address BA_A,B, write enable signal WEB_A,B and row address strobe signal RASB_A,B each applied via first and second ports 60 and 61 to generate gating signals PA and PB having timing shown in FIG. 14B. For example, when gating signal PA is outputted with a logic low from gating part 30a, path decision signal MA is outputted as a logic low. When gating signal PA is output with a logic low, the gating signal PB is maintained as a logic high and path decision signal MB is outputted as a logic high. When a row address strobe signal RASB is first input through one of the ports, gating part 30a arranges the shared memory bank 12 to accommodate the used port. For example, when row address strobe signals RASB are applied from the first and second ports simultaneously, a processor having a priority according to a system specification may access shared memory bank 12.

Control unit 30 comprises inverters 30b, 30c, 30h and 30i and NAND gates 30d and 30e, delay devices 30f and 30g, and NAND gates 30h and 30i, with a wiring structure shown in FIG. 14. In this configuration, path decision signal MA is represented as a signal with the gating signal PA delayed by a given time and latched, and path decision signal MB is represented as a signal with the gating signal PB delayed by a given time and latched.

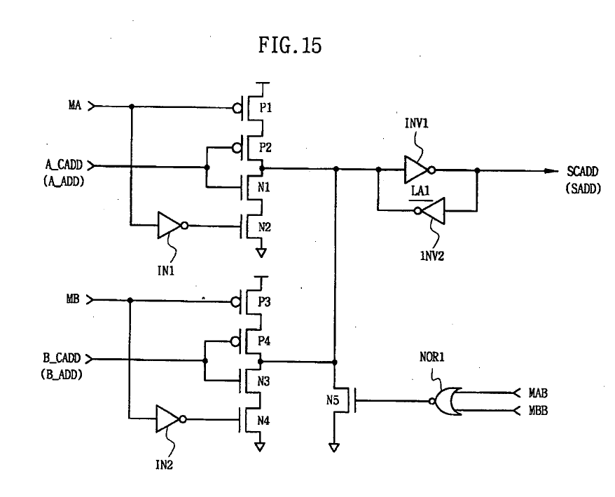

FIG. 15 illustrates in detail the row or column address multiplexer 70 or 71 referred to in FIG. 13. In particular, column address multiplexer 70 selects one of an output address A_CADD applied from the address buffer of the first port and an output address B_CADD applied from address buffer of the second port to output it as a selection column address SCADD. In addition, row address multiplexer 71 selects one of an output address A_ADD applied from address buffer of the first port and an output address B_ADD applied from the address buffer of second port, to output it as selection row address SADD. The address multiplexer shown in FIG. 15 is an example row address multiplexer 71 and column address multiplexer 70 shown in FIG. 13. That is, one address multiplexer is obtained by using the same circuit devices and functions as a row address multiplexer or a column address multiplexer based on the received input signal. Column address multiplexer 70 comprises clocked-CMOS inverters constructed of PMOS and NMOS transistors P1-P4 and N1-N4, and an inverter latch LA1 constructed of inverters INV1 and INV2. Column address multiplexer 70 receives via two input terminals two column addresses A_CADD and B_CADD through two ports and selects one of two inputs according to a logic state of path decision signal MA, MB and outputs it as a selection column address SCADD. An NMOS transistor N5 and a NOR gate NOR1 are adapted to provide a discharge path between an input terminal of inverter latch LA1 and ground. Inverters IN1 and IN2 are adapted to invert a logic state of path decision signal MA, MB. For example, when path decision signal MA is applied with a logic low, column address A_CADD applied through first port 60 is inverted through an inverter constructed of PMOS and NMOS transistors P2 and N1 and is again inverted through inverter INV1 and outputted as selection column address SCADD. In this case, path decision signal MB is applied with a logic high and column address B_CADD, which can be applied through second port 61, is not supplied to an input terminal of latch LA1 since the inverter constructed of PMOS and NMOS transistors P4 and N3 is in an inactive state. As a result, column address B_CADD, which can be applied through second port 61, is not outputted as selection column address SCADD. Furthermore, when an output of NOR gate NOR1 becomes a logic high, NMOS transistor N5 is turned on and a logic level latched to latch LA1 is initiated as a logic low.

In an embodiment of the invention, when a port has a power-down mode or sleep mode, memory banks or blocks assigned corresponding to respective ports are all self-refreshed by a refresh controller without an applied specific bank address. That is, a refresh per port can be performed according to an operation mode per port in memory areas, thereby obtaining a partial refresh based on a state of port. Therefore, a complication problem for the control can be solved, and power consumption is reduced. In addition, a data access for other memory areas can be ensured independently of a memory area performing a refresh. Moreover, a chip size increase can be suppressed and a design of circuit can be relatively more simplified.

Although the present invention has been described in connection with the embodiment of the present invention illustrated in the accompanying drawings, it is not limited thereto. It will be apparent to those skilled in the art that various substitutions, modifications and changes may be made thereto without departing from the scope and spirit of the invention.

What is claimed is:

1. A semiconductor memory device for use in a multiprocessor system having a plurality of processors comprising:
a plurality of ports correspondingly connected to said plurality of processors;
a memory cell array including a plurality of memory areas having a predetermined memory capacity, said plurality of memory areas each assigned to at least one of the plurality of ports, said plurality of memory areas each accessed by any one of at least one corresponding processor through a corresponding port; and
a refresh controller disposed between said plurality of ports and said plurality of memory areas, said refresh controller configured to refresh at least one memory area assigned to a port connected to a processor which is in a predetermined operating mode.

2. The device of claim 1 wherein at least one of the plurality of memory areas is operationally connected to one port.

3. The device of claim 1 wherein each of the memory areas is a memory bank.

4. The device of claim 1 wherein the refresh operation in the predetermined operating mode is a self-refresh operation.

5. The device of claim 1 wherein the refresh controller further comprising an internal register configured to store assignment information associated with the memory areas for each of the plurality of ports.

6. The device of claim 5 wherein the internal register is a mode register set circuit.

7. The device of claim 6 wherein the assignment information per port stored in the mode register set circuit is variable by an external control.

8. The device of claim 3, wherein the memory banks are comprised of a dedicated memory bank accessed by only one corresponding processor of the processors.

9. The device of claim 1, wherein the memory areas comprises:
a dedicated memory area accessed dedicatedly by one corresponding processor of the processors; and
a shared memory area accessed in common by at least two corresponding processors of the processors.

10. The device of claim 1, wherein the refresh controller comprises:
a refresh address counter for generating a refresh internal address;
a refresh timer coupled to said refresh address counter and configured to generate a refresh period signal; and
a refresh control circuit coupled to said refresh address counter and said refresh timer, said refresh control circuit configured to apply a self-refresh start signal to said refresh timer, said refresh control circuit further configured to apply a counting enable signal to said refresh address counter and to apply said refresh internal address to a row decoder.

11. A semiconductor memory device for use in a multiprocessor system having a plurality of processors comprising:
a plurality of ports correspondingly connected to the plurality of processors;
a memory array including a plurality of dedicated memory areas and at least one shared memory area each assigned to at least one of the plurality of ports to allow any one of at least one corresponding processor to access thereto through a corresponding port, the memory areas having a predetermined memory capacity; and
a refresh controller communicating with said plurality of ports and said plurality of memory areas, said refresh controller configured to refresh at least one memory area assigned to a port connected to a processor which does not access to any one of the at least one memory area.

12. The device of claim 11 further comprising an internal register for storing assignment information for the memory areas associated with each of the plurality of ports.

13. The device of claim 12 wherein the internal register is a mode register set circuit.

14. The device of claim 13, wherein the assignment information associated with each of the plurality of per ports stored in the mode register set circuit is varied by an external control.

15. The device of claim 11, wherein each of the memory areas is a memory bank.

16. The device of claim 11, wherein the refresh controller comprises:
a refresh address counter for generating a refresh internal address;
a refresh timer coupled to said refresh address counter and configured to generate a refresh period signal; and
a refresh control circuit coupled to said refresh address counter and said refresh timer, said refresh control circuit configured to apply a self-refresh start signal to said refresh timer, said refresh control circuit further configured to apply a counting enable signal to said refresh address counter and to apply said refresh internal address to a row decoder.

17. The device of claim 14 further comprising a shared register logically connected outside the memory cell array and corresponding to a disabled area of the shared memory area.

18. The device of claim 17 wherein the shared register comprises a semaphore area and mailbox areas distinguished from each other by a column address.

19. The device of claim 18 wherein the shared register is accessed corresponding to a specific row address of the shared memory area.

20. A method of refreshing a semiconductor memory device for use in a multiprocessor system, the semiconductor memory device including a plurality of ports correspondingly connected to a plurality of processors of the multiprocessor system, and a memory cell array including a plurality of dedicated memory areas and at least one shared memory area which each are assigned to at least one of the plurality of ports and have a predetermined memory capacity, the method comprising:
reading assignment information on assigning the plurality of memory areas to the plurality of ports; and
refreshing at least one memory area assigned to a port connected to a processor which does not access to any one of the at least one memory area by performing a refresh control according to the assignment information.
